(19) United States
(12) Patent Application Publication
(10) Pub. No.: US 2012/0303708 A1
(43) Pub. Date: Nov. 29, 2012

(54) APPARATUS AND METHOD FOR PROVIDING COMMUNITY SERVICE IN MOBILE TERMINAL

(76) Inventors: Sun-Eung Park, Suwon-si (KR); Kil-Su Eo, Yongin-si (KR); Jae-Woo Ko, Uiwang-si (KR)

(21) Appl. No.: 13/452,770

(22) Filed: Apr. 20, 2012

(30) Foreign Application Priority Data
May 24, 2011 (KR) 10-2011-0048928

(51) Int. Cl. G06F 15/16

(52) U.S. Cl. 709/204

(57) ABSTRACT

A community service of a mobile terminal, and more particularly, an apparatus and a method for managing a user's reaction conveniently by generating a community based on contents compared to a community generated based on a Uniform Resource Locator (URL). The apparatus includes a contents information analyzer, an input unit, and a controller. The contents information analyzer analyzes information regarding contents to provide the same to a contents server when registering a user reaction to the contents that are being reproduced. The input unit receives a user's reaction to the contents. The controller processes to transmit the received user's reaction to a community server.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on May 24, 2011 and assigned Serial No. 10-2011-0048928, the entire disclosure of which is hereby incorporated by reference.

### TECHNICAL FIELD OF THE INVENTION

The present disclosure relates to a community service of a mobile terminal. More particularly, the present disclosure relates to an apparatus and a method for managing a user's reaction conveniently by generating a community based on contents compared to a community generated based on a Uniform Resource Locator (URL).

### BACKGROUND OF THE INVENTION

Recently, a mobile terminal has become a necessity indispensable to modern people and is widely used regardless of age or sex, and service providers and terminal manufacturers competitively develop products (or services) for differentiation from other companies.

For example, the mobile terminal has developed to a multimedia apparatus that can provide a phonebook, games, a Short Message Service (SMS), an Electronic (E)-mail, a morning call, a Motion Picture Expert Group Audio Layer-3 (MP3) player, a schedule management function, a digital camera, a multimedia message, and a wireless Internet service, to provide various services.

Recently, a mobile terminal provides a community service sharing information regarding a plurality of contents via a wireless Internet.

For example, a user may access a website using the mobile terminal, and then input the user's reaction to articles, photos, and the like, posted on the accessed website. In addition, the user may search for information regarding media contents that have been reproduced and register a reaction to the media contents in a specific site using the mobile terminal.

FIGS. 1A and 1B illustrate a process for providing a community service in a mobile terminal.

Referring to FIGS. 1A and 1B, it is assumed that the mobile terminal accesses a home page of Samsung Electronics and a user of the mobile terminal intends to view information regarding a product (contents) “Galaxy S II”.

The user of the mobile terminal may view other users' opinions regarding a product “Galaxy S II” and register the user's own opinion via a community service. The present disclosure may define this circumstance as generating and using a community.

Generally, when a user of the mobile terminal accesses a page introducing a product “Galaxy S II”, the mobile terminal outputs a screen allowing a user to input the user's opinion and information regarding the product registered in advance.

As illustrated in FIGURE IA, users' opinions of “very good”, “light”, and “fast” are registered with respect to the product, and a user of a mobile terminal has currently input (101) the user's opinion in order to input an opinion of “performance is excellent!” with respect to the product.

When the user presses a register button after inputting his opinion, the mobile terminal incorporates (103) the opinion input by the user into the opinions registered in advance as illustrated in FIG. 1B.

The opinion registered by the user of the mobile terminal is stored in a relevant website, and the user should manage the opinion registered by the user separately. This is because the community service is provided based on a URL.

When contents that use the community service increase, a user cannot view contents in which the user's opinion has been registered.

Therefore, to solve the above problem, an apparatus and a method for managing contents in which a user's opinion has been registered are required.

### SUMMARY OF THE INVENTION

To address the above-discussed deficiencies of the prior art, it is an aspect of the present disclosure to provide an apparatus and a method for generating a community based on contents in a mobile terminal.

Another aspect of the present disclosure is to provide an apparatus and a method for determining a registered user's reaction with respect to a user's reaction in a mobile terminal.

Still another aspect of the present disclosure is to provide an apparatus and a method for managing a reaction of a community that a user has registered in a mobile terminal.

In accordance with an aspect of the present disclosure, an apparatus for providing a community service in a mobile terminal is provided. The apparatus includes a contents information analyzer configured to analyze information regarding contents to provide the information to a contents server when registering a user's reaction to the contents that are being reproduced. The apparatus also includes an input unit configured to receive a user's reaction to the contents, and a controller configured to process to transmit the received user's reaction to a community server.

In accordance with another aspect of the present disclosure, an apparatus for providing a community service in a community server is provided. The apparatus includes an identification (ID) generator configured to generate an independent ID for contents when receiving contents information. The apparatus also includes a server controller configured to process to load a reaction to the generated ID among user reactions for each contents stored in advance and transmit the reaction to a mobile terminal.

In accordance with still another aspect of the present disclosure, a method for providing a community service in a mobile terminal is provided. The method includes, when registering a user reaction to contents that are being reproduced, analyzing information regarding the contents to provide the information to a contents server. The method also includes receiving a user's reaction to the contents, and transmitting the received user's reaction to a community server.

In accordance with yet another aspect of the present disclosure, a method for providing a community service in a community server is provided. The method includes, when receiving contents information, generating an independent identification (ID) for the contents. The method also includes loading a reaction to the generated ID among user reactions for each contents stored in advance and transmitting the reaction to a mobile terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A and 1B illustrate a process for providing a community service in the general mobile terminal;

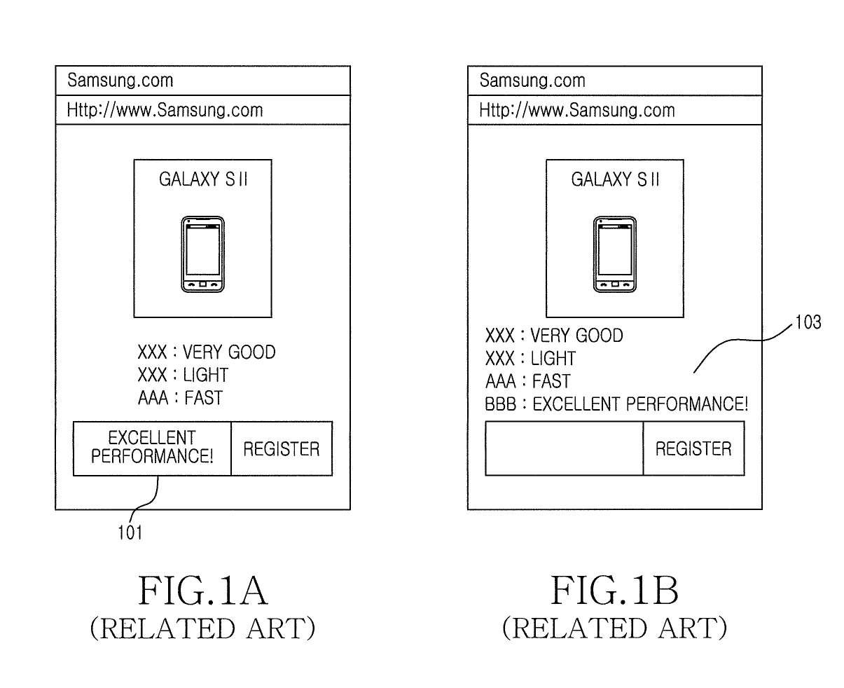

FIG. 2 illustrates a mobile communication system for providing a community service according to an embodiment of the present disclosure;

FIG. 3 illustrates a process for using a community service in a mobile terminal according to an embodiment of the present disclosure;

FIG. 4 illustrates a process for providing a community service in a community server according to an embodiment of the present disclosure;

FIG. 5 illustrates a process for informing contents reaction registration in a community server according to an embodiment of the present disclosure;

FIG. 6 illustrates a process for providing a community service in a mobile communication system according to an embodiment of the present disclosure; and

FIG. 7 illustrates information of a community stored in a mobile terminal according to an embodiment of the present disclosure.

Throughout the drawings, like reference numerals will be understood to refer to like parts, components and structures.

### DETAILED DESCRIPTION OF THE INVENTION

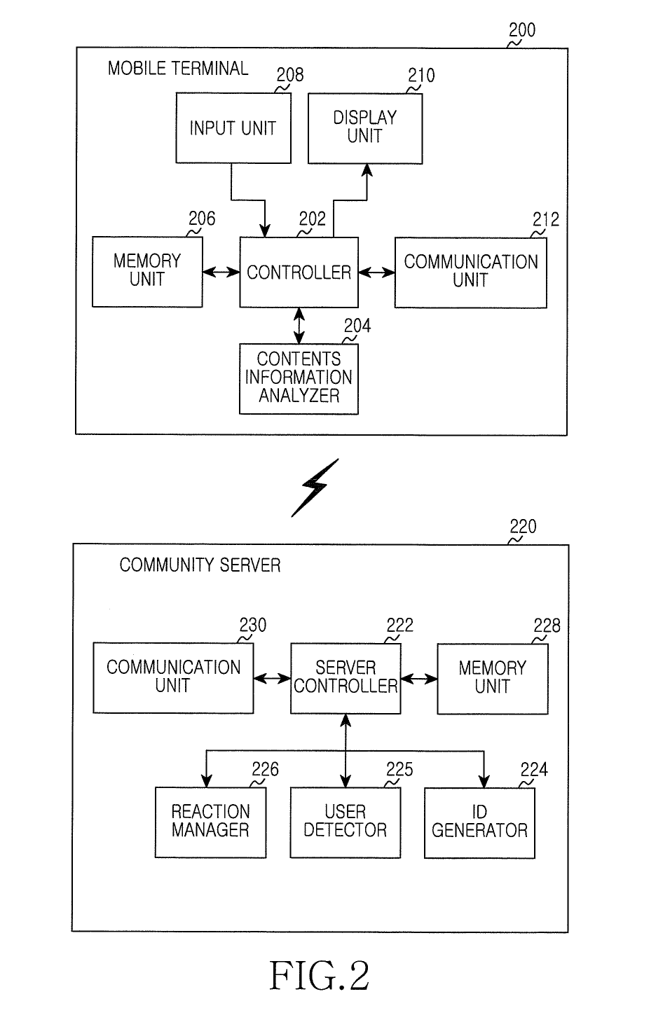

FIGS. 2 through 7, discussed below, and the various embodiments used to describe the principles of the present disclosure in this patent document are by way of illustration only and should not be construed in any way to limit the scope of the disclosure.

Exemplary embodiments of the present disclosure provide an apparatus and a method for generating a community based on contents and providing a user's reaction to relevant contents in a mobile terminal.

FIG. 2 illustrates a mobile communication system for providing a community service according to an embodiment of the present disclosure.

Referring to FIG. 2, the mobile communication system may include a mobile terminal 200 and a community server 220. The mobile terminal 200 may include a controller 202, a contents information analyzer 204, a memory unit 206, an input unit 208, a display unit 210, and a communication unit 212.

The controller 202 of the mobile terminal 200 controls an overall operation of the mobile terminal 200. For example, the controller 202 performs processes and controls for voice communication and data communication. In addition to the general functions, according to an embodiment of the present disclosure, the controller 202 processes to generate a contents-based community. Here, the community denotes a service that can share a plurality of users' opinions with respect to specific contents.

The controller 202 classifies and registers contents in which a user's reaction is registered by analyzing contents information for the community and providing the same to the community server 220.

In addition, the controller 202 provides a reaction to contents received from a user to the community server 202, and processes to receive reactions of a plurality of persons to relevant contents from the community server 220.

The contents information analyzer 204 analyzes contents to which users' reactions are to be shared and provides the same to the community server 220 under control of the controller 202, and manages community information including information regarding contents in which users' reactions have been registered.

The memory unit 206 preferably includes, for example, a Read Only Memory (ROM), a Random Access Memory (RAM), a flash ROM, and such. The ROM stores microcodes of programs for processes and controls of the controller 202 and the contents information analyzer 204, and various reference data. In addition, according to an embodiment of the present disclosure, the memory unit 206 stores information regarding contents in which a user's reaction has been registered.

The methods described herein may be provided as one or more instructions in one or more software modules stored in the storage device. The software modules may be executed by the controller.

The RAM serves as a working memory of the controller 202 and stores temporary data that occur during execution of various programs. In addition, the flash ROM stores various updatable data for storage such as a phonebook, calling messages, and received messages.

The input unit 208 includes a plurality of function keys such as numerical key buttons of 0 to 9, a menu button, a cancel button, an OK button, a TALK button, an END button, an Internet access button, navigation key (or directional key) buttons, letter input keys, and the like, and provides key input data corresponding to a key pressed by a user to the controller 202. In addition, the input unit 208 receives a user's reaction to contents and provides the same to the controller 202.

The display unit 210 displays status information generated during an operation of the mobile terminal 200, characters, a large amount of moving images and still images, and the like. The display unit 210 may be a color Liquid Crystal Display (LCD), an Active-Matrix Organic Light-Emitting Diode (AMOLED), and such. The display unit 210 may include a touch input device, and when it is applied to a touch input type mobile terminal, it can be used as an input unit. In addition, the display unit 210 outputs information occurring from a community generated according to an embodiment of the present disclosure, and outputs a user's reaction to each contents. A touch sensitive display, called as a touch screen, may be used as the display unit. Touch input may be performed via the touch sensitive display.

The communication unit 212 transmits and receives a Radio Frequency (RF) signal of data input/output via an antenna (not illustrated). For example, during transmission, the communication unit 212 channel-codes and spreads data to be transmitted, and then performs an RF process on the signal to transmit the signal. During reception, the communication unit 212 converts a received RF signal into a baseband signal, and despreads and channel-decodes the baseband signal to recover data. In addition, according to an embodiment of the present disclosure, the communication unit 212 transmits and receives information associated with a community service. The communication unit 212 transmits a reaction received from a user to the community server 220, and receives a reaction to contents registered in advance from the community server 220.

The function of the contents information analyzer 204 may be performed by the controller 202 of the mobile terminal 200. The separate configuration and illustration of the contents information analyzer 204 are for example purposes only and for convenience in description, not for limiting the scope of the present disclosure. It would be obvious to those skilled in the art that various modifications may be made within the scope of the present disclosure. For example, all functions of the contents information analyzer 204 may be processed by the controller 202.

The community server 220 may include a server controller 222, an ID generator 224, a user detector 225, a reaction manager 226, a memory unit 228, and a communication unit 230.

The server controller 222 of the community server 220 processes to provide a contents-based community service. According to an embodiment of the present disclosure, the server controller 222 classifies and registers contents to which a user's reaction is to be registered, and processes to store and manage a reaction to the registered contents.

In addition, when a reaction received from the mobile terminal 200 is a reaction to a previous writing by a user, the server controller 222 processes to inform the user who has written the writing that a response reaction has been registered.

The ID generator 224 processes to register contents in which a user's reaction is to be registered under control of the server controller 222. At this point, the ID generator 224 analyzes contents information received from the mobile terminal 200 to classify contents in which a user's reaction is to be registered and gives a specific ID to the contents.

The user detector 225 determines a user who has registered a reaction to contents and provides the same to the server controller 222 under control of the server controller 222.

The reaction manager 226 manages a reaction to contents. The reaction manager 226 receives and stores a reaction to contents, and processes to provide other users' reactions to the stored contents to the mobile terminal 200.

The memory unit 228 stores microcodes of a program for operating the community server 220 and various reference data. According to an embodiment of the present disclosure, the memory unit 228 stores a reaction to contents registered by a user, and the communication unit 230 communicates with the mobile terminal 200. According to an embodiment of the present disclosure, the communication unit 230 receives a reaction received from a user, and transmits a reaction to contents registered in advance to the mobile terminal 200.

The ID generator 224, the user detector 225, and the reaction manager 226 may be included in the community server 220 as illustrated, but they may be configured as separate servers independent of the community server 220. For example, they may be configured as the contents ID manage server, a user information manage server, and a reaction information manage server, respectively.

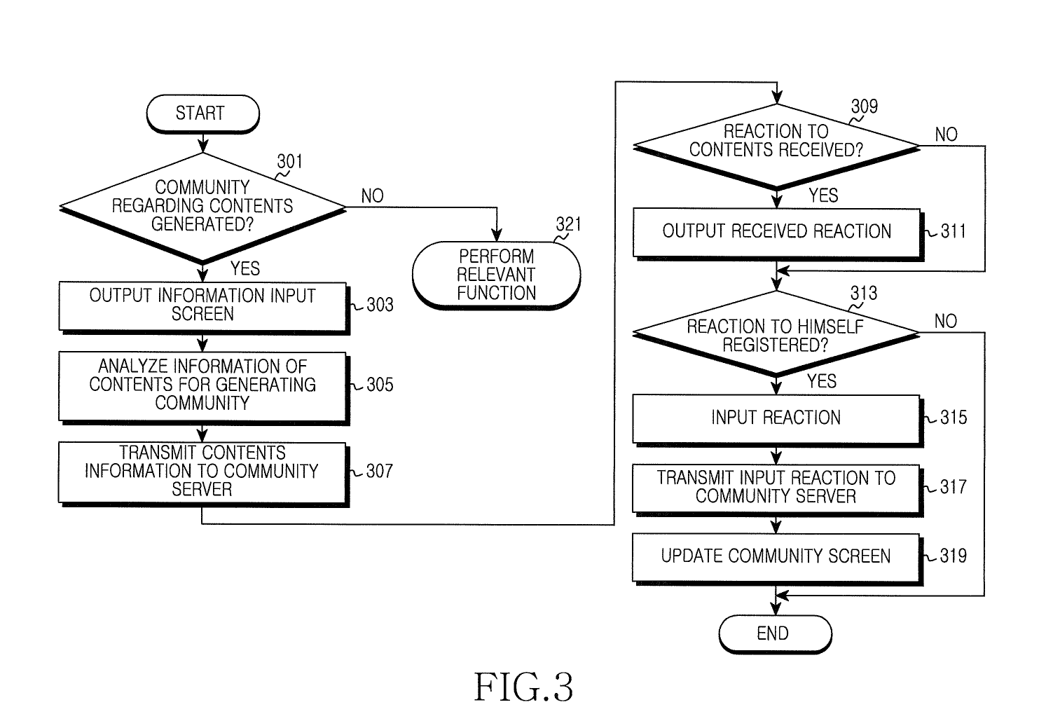

FIG. 3 illustrates a process for using a community service in a mobile terminal according to an embodiment of the present disclosure.

Referring to FIG. 3, the mobile terminal determines whether to generate a community for contents in block 301. Here, the community denotes a service allowing a plurality of users to share opinions for specific contents. A user may register his opinion for contents by inputting a button (for example, an opinion register button) for generating a community while the contents are reproduced.

A general mobile terminal generates a URL-based community, and opinions of a user himself (or herself) and other users are stored in a relevant site, so the user has an inconvenience in managing the opinions registered by the user himself.

When the mobile terminal does not generate a community for contents in block 301, the mobile terminal proceeds to block 321 to perform a relevant function (for example, an idle mode).

Alternatively, upon a determination that the mobile terminal has generated a community for contents in block 301, in other words, when detecting an input of the button for generating a community while the contents are reproduced, the mobile terminal proceeds to block 303 to output an information input screen. Here, the information input screen denotes a screen for allowing a user to input an opinion for contents and a screen in which other users' opinions for the contents have been registered.

The mobile terminal proceeds to block 305 to analyze information of contents in order to generate a community, and proceeds to block 307 to transmit the analyzed contents information to a community server and register contents for generating the community. At this point, the mobile terminal analyzes information that can classify contents in order to register the generated contents in the community server. For example, the contents information may be information of a player reproducing the contents, meta information of reproduced contents, a filename of reproduced contents, and the like.

The mobile terminal proceeds to block 309 to determine whether other users' reactions (opinions) to the contents are received from the community server. Here, the reaction to the contents may be an opinion posted by a different user and a comment for the opinion. When a different user's reaction to the contents is registered, the community server may provide the reaction to the mobile terminal.

Upon a determination that a different user's reaction for the contents is received in block 309, the mobile terminal proceeds to block 311 to output the received reaction to the contents and proceeds to block 313 to determine whether to register the user's reaction for the contents.

Alternatively, upon a determination that a different user's reaction for the contents is not received in block 309, the mobile terminal re-performs the process of block 313.

Upon a determination not to register the user's opinion for the contents in block 313, the mobile terminal ends the present algorithm.

Alternatively, upon a determination to register the user's opinion for the contents in block 313, the mobile terminal proceeds to block 315 to receive a reaction of the user himself via the information input screen output in block 303.

When the reaction of the user is received, the mobile terminal proceeds to block 317 to transmit the received reaction to the community server, and proceeds to block 319 to update a community screen. Here, block 319 is to register and output the reaction written by the user of the mobile terminal.

After that, the mobile terminal ends the present algorithm according to an embodiment of the present disclosure.

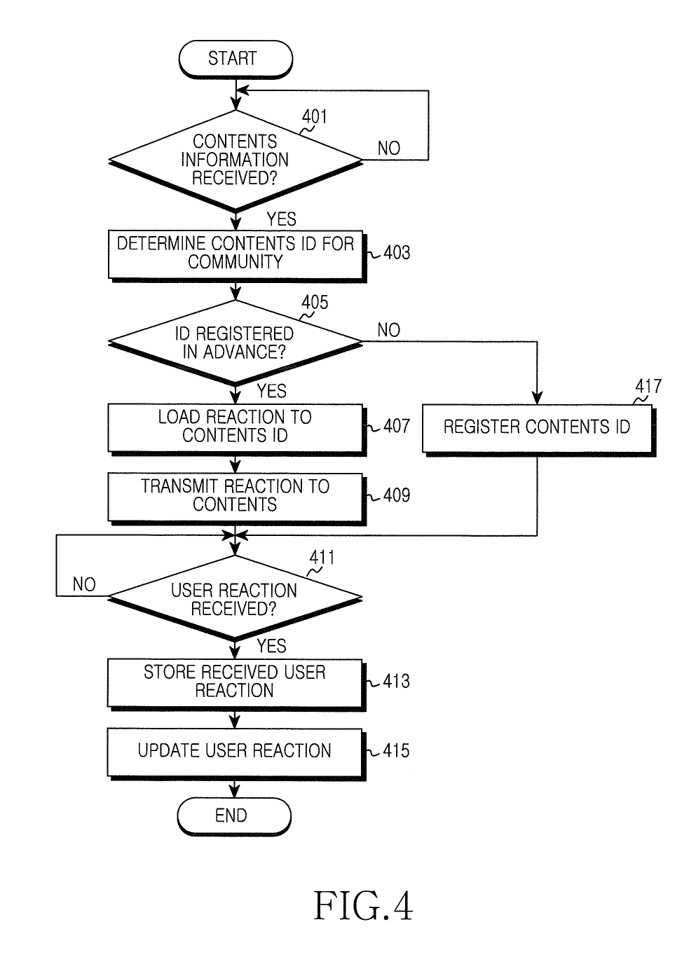

FIG. 4 illustrates a process for providing a community service in a community server according to an embodiment of the present disclosure.

Referring to FIG. 4, the community server determines whether contents information is received from the mobile terminal in block 401. Here, the contents information denotes information for classifying contents in which the user's reaction is registered. The contents information may be information of a player reproducing contents, meta information of reproduced contents, a filename of reproduced contents, and the like.

Upon a determination that contents information is not received in block 401, the community server re-performs the process of block 401.

Alternatively, upon a determination that contents information is received in block 401, the community server proceeds to block 403 to determine an ID for the contents. That is, the community server generates an ID for contents provided from the mobile terminal using the received contents information. For example, in a situation where contents are reproduced via a media player and contents information that a filename is ‘A’ is received, the community server determines an ID for the media file called ‘A’. The ID is differently generated for every contents. This is because the community server receives contents information from a plurality of mobile terminals and so it is preferable that the community server gives an ID for each contents rather than the mobile terminal giving an ID for each contents.

The community server proceeds to block 405 to determine whether the ID determined in block 403 is an ID registered in advance. That is, the community server determines whether a community generate request has been received with respect to the contents in which a user's reaction has been registered in advance.

Upon a determination that the ID is an ID registered in advance in block 405, the community server proceeds to block 407 to load a reaction for a contents ID stored in advance, and proceeds to block 409 to transmit the loaded reaction of the contents to the mobile terminal.

Alternatively, upon a determination that the ID is not an ID registered in advance in block 405, the community server proceeds to block 417 to store the contents ID.

The community server that has performed block 409 or block 417 proceeds to block 411 to determine whether a user's reaction for contents is received.

Upon a determination that the user's reaction for contents is not received in block 411, the community server re-performs the process of block 411.

Alternatively, upon a determination that the user's reaction for contents is received in block 411, the community server proceeds to block 413 to store the received user's reaction, and proceeds to block 415 to update the user's reaction. Block 415 is to register a reaction written by the user of the mobile terminal in relevant contents.

After that, the community server ends the present algorithm.

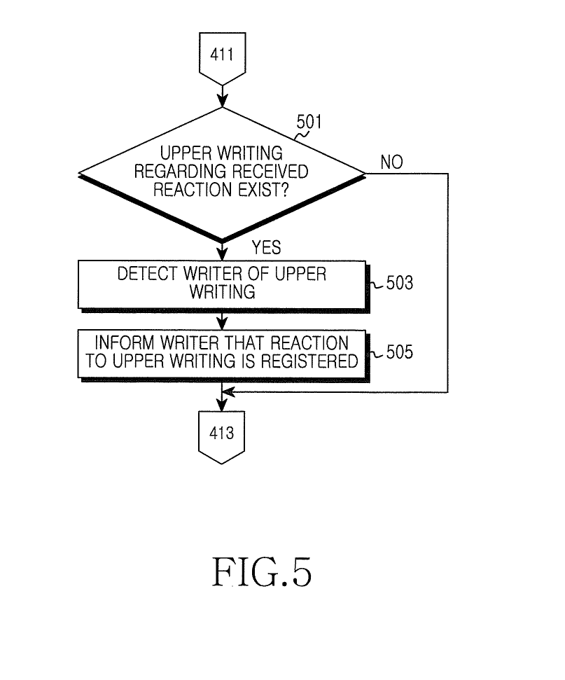

FIG. 5 illustrates a process for informing contents reaction registration in a community server according to an embodiment of the present disclosure.

Referring to FIG. 5, the community server determines whether a previous writing for a user's reaction received from a mobile terminal exists in block 501. Here, block 501 is to determine whether the user's reaction received in block 411 of FIG. 4 is a comment regarding a response registered in advance.

Upon a determination that an upper writing for the received reaction does not exist in block 501, the community server ends the present algorithm.

Alternatively, upon a determination that an upper writing for the received reaction exists in block 501, the community server proceeds to block 503 to detect a writer of the upper writing and proceeds to block 505 to inform the writer of the upper writing that the reaction to the upper writing has been registered.

After that, the community server performs the process of block 413 of FIG. 4.

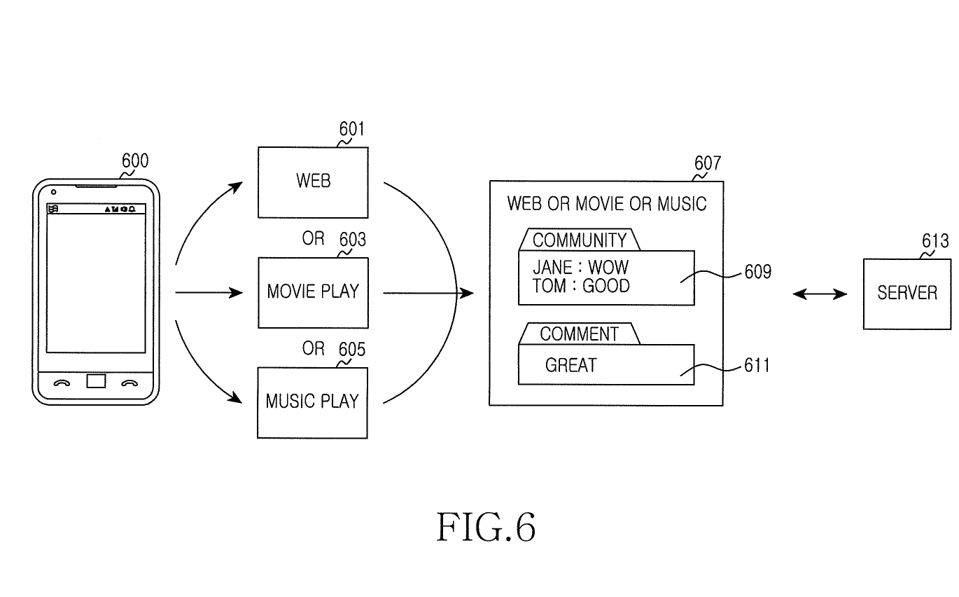

FIG. 6 illustrates a process for providing a community service in a mobile communication system according to an embodiment of the present disclosure.

Referring to FIG. 6, the mobile communication system includes a mobile terminal 600 and a community server 613. The mobile terminal 600 may register a reaction to contents using a community service.

For example, the mobile terminal 600 may execute a web browser 601 or perform contents reproduction such as movie reproduction 603 and music reproduction 605.

When a user intends to register an opinion (reaction) regarding contents that are being reproduced, the mobile terminal 600 outputs a community screen capable of sharing a user's reaction as illustrated by a reference numeral 607. At this point, a user of the mobile terminal 600 may output the community screen by inputting a community execute button of the mobile terminal 600 or a community execute button output on the screen of the mobile terminal 600.

In addition, the mobile terminal 600 analyzes information regarding contents that are being reproduced to transmit the same to the community server 613, and receives a user's reaction to contents from the community server 613 to output the same.

The mobile terminal 600 receives a reaction to contents from a user to update a reaction to the contents.

For example, the mobile terminal 600 receives a reaction to the contents from the community server 613, and so outputs reactions 609 registered by Jane and Tom.

After that, the mobile terminal 600 receives a reaction 611 of “Great” from a user and transmits the same to the community server 613.

Accordingly, when using a community service for the contents, a reaction registered by the user of the mobile terminal 600 may be viewed together and the reaction is managed for each contents.

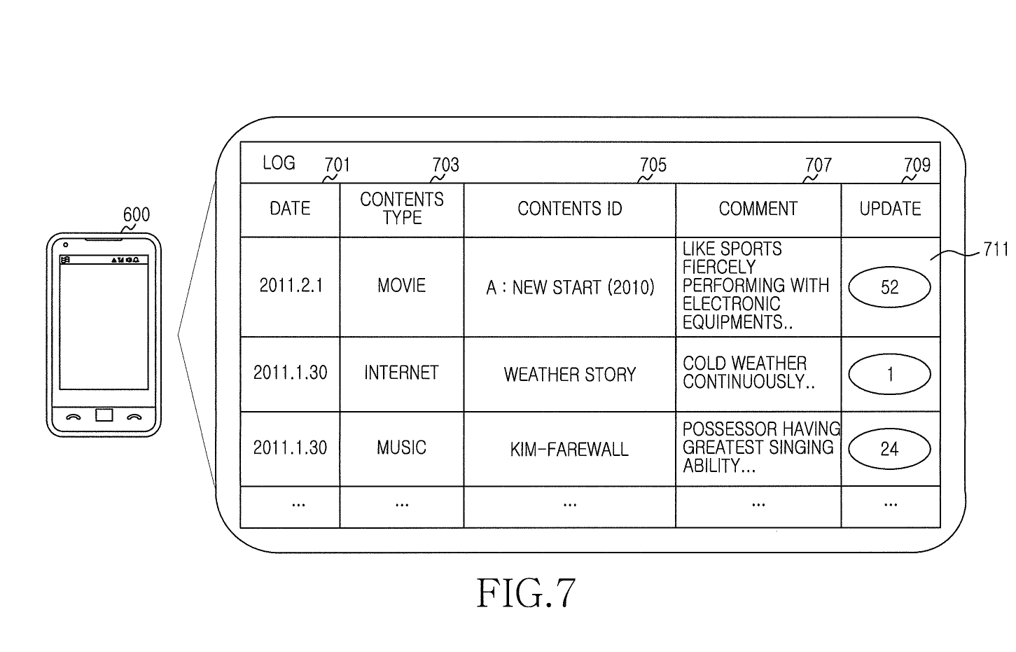

FIG. 7 illustrates information of a community stored in a mobile terminal according to an embodiment of the present disclosure.

Referring to FIG. 7, the information of the community is an example of information regarding a community generated by a user of the mobile terminal 700, and denotes information regarding contents in which the reaction of the user has been registered.

The user of the mobile terminal 700 has generated a community regarding a movie, a web page, and music contents, and registered a user's reaction thereto.

Specifically, the community information is log information in which a reaction of a user is stored, and includes information of a time 701 at which a reaction of the user has been registered, a contents type 703 in which a reaction of the user been registered, an ID 705 of contents in which a reaction of the user has been registered, a reaction content 707 of the user for contents, an updated reaction frequency 709 of contents in which the user has been registered, and the like.

For example, the mobile terminal 700 generated a community regarding a movie “A” (new start (2010)) on Feb. 1, 2011, and registered a reaction “Like sports fiercely performing with electronic equipments . . . ”. The mobile terminal stores community information that 52 reactions have been registered (711) in the contents.

It will be appreciated that embodiments of the present disclosure can be realized in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As described above, the present disclosure is for generating a community based on contents in a mobile terminal and providing a user's reaction to relevant contents. The present disclosure may easily manage a reaction to contents compared to a method of generating a community based on a URL.

Although the disclosure has been shown and described with reference to certain exemplary embodiments thereof, it will be understood by those skilled in the art that various changes in form and details may be made therein without departing from the spirit and scope of the disclosure as defined by the appended claims and their equivalents. Therefore, the scope of the present disclosure should not be limited to the above-described embodiments but should be determined by not only the appended claims but also the equivalents thereof.

What is claimed is:

1. An apparatus for providing a community service in a mobile terminal, the apparatus comprising:
a contents information analyzer configured to analyze information regarding contents to provide the information to a contents server when registering a user's reaction to the contents that are being reproduced;
an input unit configured to receive a user's reaction to the contents; and
a controller configured to process to transmit the received user's reaction to a community server.

2. The apparatus of claim 1, further comprising a display unit configured to output a reaction to the contents,
wherein when receiving a user's reaction registered in advance from the community server, the controller is further configured to process to output the received user's reaction.

3. The apparatus of claim 1, wherein the controller is configured to transmit the received user's reaction to the community server, and receive a notice informing that a response to the registered reaction is registered from the community server.

4. The apparatus of claim 1, wherein the controller is configured to transmit the received user's reaction to the community server, and store information regarding contents in which the user's reaction has been registered.

5. The apparatus of claim 1, wherein the user's reaction comprises at least one of an opinion regarding the contents, and a comment regarding the opinion.

6. An apparatus for providing a community service in a community server, the apparatus comprising:
an identification (ID) generator configured to generate an independent ID for contents when receiving contents information; and
a server controller configured to process to load a reaction to contents corresponding to the generated ID among user reactions for each contents stored in advance and transmit the reaction to a mobile terminal.

7. The apparatus of claim 6, further comprising a memory unit configured to receive reaction information from the mobile terminal and to store the reaction information as reaction information regarding relevant contents.

8. The apparatus of claim 6, wherein when the generated ID is not an ID registered in advance, the server controller registers the generated ID.

9. The apparatus of claim 7, further comprising a user detector configured to manage information of a user who has written a reaction to the contents, wherein the controller is configured to:
receive reaction information from the mobile terminal,
determine whether the received reaction information is reaction information regarding an upper writing,
when the reaction information is regarding the upper writing, detect a writer of the upper writing via the user detector, and
inform that a response to the reaction written in advance is registered.

10. The apparatus of claim 6, wherein the reaction comprises at least one of an opinion regarding the contents, and a comment regarding the opinion.

11. A method for providing a community service in a mobile terminal, the method comprising:
when registering a user reaction to contents that are being reproduced, analyzing information regarding the contents to provide the information to a contents server;
receiving a user's reaction to the contents; and
transmitting the received user's reaction to a community server.

12. The method of claim 11, further comprising:
after analyzing information regarding the contents to provide the information to the contents server, receiving a user's reaction registered in advance to the contents; and
outputting the received user's reaction.

13. The method of claim 11 further comprising, after transmitting the received user's reaction to the community server, receiving a notice informing that a response to a registered reaction is registered from the community server.

14. The method of claim 11, further comprising, after transmitting the received user's reaction to the community server, storing information regarding contents in which the user's reaction has been registered.

15. The method of claim 11, wherein the user's reaction comprises at least one of an opinion regarding the contents, and a comment regarding the opinion.

16. A method for providing a community service in a community server, the method comprising:
when receiving contents information, generating an independent identification (ID) for the contents; and
loading a reaction to contents corresponding to the generated ID among user reactions for each contents stored in advance and transmitting the reaction to a mobile terminal.

17. The method of claim 16, further comprising receiving reaction information from the mobile terminal to store the reaction information as reaction information regarding relevant contents.

18. The method of claim 16, further comprising, when the generated ID is an ID registered in advance, registering the generated ID.

19. The method of claim 17, further comprising:
after receiving reaction information from the mobile terminal, determining whether the received reaction information is reaction information regarding an upper writing;
when the reaction information is regarding the upper writing, detecting a writer of the upper writing; and
informing the detected writer that a response to the reaction written in advance is registered.

20. The method of claim 16, wherein the reaction comprises at least one of an opinion regarding the contents, and a comment regarding the opinion.
